(19) United States
(12) Patent Application Publication
(10) Pub. No.: US 2009/0151371 A1
(43) Pub. Date: Jun. 18, 2009

(54) POWER SAVING TYPE COMPRESSOR AND REFRIGERATOR WITH THE SAME AND METHOD FOR CONTROLLING THE SAME

(75) Inventors: Sang Joon Eum, Gyeongsangnam-do (KR); Yun Hi Lee, Gyeongsangnam-do (KR); Yeon Woo Kim, Gyeongsangnam-do (KR); Seoung Min Kang, Gyeongsangnam-do (KR); Jea Young Choi, Busan (KR); Jeong Ho Lee, Gyeongsangnam-do (KR); Bum Dong Sa, Gyeongsangnam-do (KR); Chang Gyu Kim, Gyeongsangnam-do (KR); Jae Hun Lee, Gyeongsangnam-do (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 12/089,137

(22) PCT Filed: Sep. 6, 2006
(86) PCT No.: PCT/KR2006/003531

§ 371 Date: Sep. 9, 2008

(30) Foreign Application Priority Data
Oct. 7, 2005 (KR) 10-2005-0094384

(51) Int. Cl. F25B 49/00; H02P 1/42

(52) U.S. Cl. 62/132; 318/792

(57) ABSTRACT

The present invention relates to a compressor (5) and a refrigerator with the same, and more particularly, to a power saving type compressor which can prevent unnecessary consumption of a current for the compressor to have high energy efficiency, and a refrigerator with the same and a method for controlling the same, wherein the power saving type compressor includes a main winding and a sub-winding respectively having a main terminal (R) and a sub-terminal(s) main winding and a sub-winding being connected with a common terminal to each other, and a PTC switching unit between a PTC unit connected to the sub-terminal for increasing a starting torque in operation of the compressor and the main terminal, for making selective switching on/off of a power input to the PTC unit.

### TECHNICAL FIELD

The present invention relates to a compressor and a refrigerator with the same, and more particularly, to a power saving type compressor which can prevent unnecessary consumption of a current for the compressor to have high energy efficiency, and a refrigerator with the same and a method for controlling the same.

### BACKGROUND ART

In general, the compressor draws low temperature, low pressure gaseous refrigerant and compresses the refrigerant to high temperature, high pressure refrigerant. A refrigerator or air conditioner or the like having the compressor applied thereto requires high quietness, and high energy efficiency compared to other home appliances in view of an operation principle and structure.

The compressor of a refrigerating cycle has a motor of various types defined according to a driving type, and a coupling structure between a stator and rotor thereof.

Recently, development of the compressor having high energy efficiency at the time of operation of the refrigerator or the air conditioner is required in view of environment and an energy saving.

“a refrigerator” described hereinafter is a concept inclusive of refrigerating systems having the refrigerating cycle applied thereto, such as freezers, kimchi refrigerators, in addition to general domestic refrigerators each having a refrigerating chamber and a freezing chamber.

A related art compressor will be described with reference to the attached drawings.

FIGS. 1 and 2 illustrate systems of related art compressors, respectively.

FIG. 1 illustrates a system of a RSCR type compressor only with a running capacitor, provided with a main winding 13 and a sub-winding 14 connected with a common terminal 15a, and a main terminal 15b at one side of the main winding 13 and a sub-terminal 15c at one side of the sub-winding 14.

The RSCR type compressor is also provided with a running capacitor (CR) 17 having a capacity enough to make balance of currents at a rated motor load, and a positive temperature coefficient (PTC) 16 which makes a starting torque greater for serving as a starting switch of the compressor motor, wherein the running capacitor (CR) 17 and the positive temperature coefficient (PTC) 16 are connected in parallel between the sub-terminal 15c and the main terminal 15b.

The main terminal 15b, and electrodes of the running capacitor 17 and the PTC unit 16 connected to the main terminal 15b are connected to one of terminals of a power supply unit in common.

Between the other terminal of the power supply unit and the common terminal 15a, there are an overload protector (OLP) 12 which is actuated when an over-current is detected for suppressing damage to the compressor motor caused by a load thereon being over a predetermined value, and a power supply switch unit 11 for turning on/off the power.

The compressor starts operation when the power supply switching unit 11 is turned on, and stops the operation when the when the power supply switching unit 11 is turned off.

A variable capacity type compressor will be described, which has switching means of relays between a power supply terminal and a main terminal and a sub-terminal to enable selection of an operation mode (saving mode, or power mode) by controlling currents flowing on the main winding and the sub-winding.

Referring to FIG. 2, the variable capacity type compressor is provided with a main winding 13 and a sub-winding 14 connected with a common terminal 15a, and a main terminal 15b at one side of the main winding 13 and a sub-terminal 15c at one side of the sub-winding 14.

The variable capacity type compressor is also provided with a running capacitor (CR) 17 having a capacity enough to make balance of currents at a rated motor load, and a starting capacitor (CS) 18 for making a great starting torque when currents on the main winding 13 and the sub-winding 14 are balanced, wherein the running capacitor (CR) 17 and the starting capacitor (CS) 18 are connected in parallel between the sub-terminal 15c and the main terminal 15b.

There is a positive temperature coefficient (PTC) 16 which makes a starting torque greater between the main terminal 15b and the starting capacitor 18 for serving as a starting switch of the compressor motor.

The main terminal 15b, and electrodes of the running capacitor 17 and the PTC unit 16 connected to the main terminal 15b are connected to one 19a of terminals of a mode selection switching unit 19 which selects an operation mode of the compressor.

The mode selection switching unit 19 is composed of a terminal connected to the power supply unit, and first, and second relays 19a, and 19b respectively connected to the main terminal 15b and the sub-terminal 15c, for being switched in response to a mode selection signal to let a current flow to the main winding 13 or to the sub-winding 14, for driving the compressor either in the power mode or in the saving mode.

Between the other terminal of the power supply unit and the common terminal 15a, there are an overload protector (OLP) which is actuated when an over-current is detected for suppressing damage to the compressor motor caused by a load thereon being a predetermined value and a power supply switch unit 11 for turning on/off the power.

The operation mode of the variable capacity type compressor is set up depending on the terminal on the power supply unit side of the mode selection switching unit 19 being connected to which one of the first, and second relay terminals 19a, and 19b, and if the power supply switching unit 11 is turned on in this state, the compressor is operated in the set up operation mode, and the compressor stops when the power supply switching unit 11 is turned off.

The variable capacity type compressor is provided with relay switches respectively on the main winding 13 and the sub-winding 14 which enable change of the mode, to provide outputs different from each other depending on a direction of rotation either in a clockwise (C.W) direction or in a counter clockwise (C.C.W) direction.

According to this, in the clockwise direction rotation, a power source voltage is applied to the main winding 13 directly, and to the sub-winding through the capacitor and the starting switch, and vice versa in the counter clockwise direction rotation.

In general, in order to improve a starting performance and efficiency of the compressor motor, the main winding 13 has a thicker line, with a many number of windings, while the sub-winding 14 has a thinner line, with a small number of windings.

The main winding 13 has a thicker line for a greater torque, and a number of windings more than the sub-winding 14 for delaying a phase of a current by means of inductance L.

### DISCLOSURE OF INVENTION

### Technical Problem

However, the related art compressor and a related art refrigerator having the related art compressor applied thereto have the following problems.

The positive temperature coefficient (PTC), connected between the sub-terminal and the main terminal for making the starting torque greater to serve as a starting switch of the compressor motor, has a current thereon failed to cut off even after rise of the starting torque, to result in consumption of unnecessary power.

Such inputs to opposite sides of the PTC unit increase power consumption of the compressor and the refrigerator having the compressor applied thereto, to impair competitiveness of the product and satisfaction of the consumers.

### Technical Solution

Accordingly, the present invention is directed to a [title] that substantially obviates one or more problems due to limitations and disadvantages of the related art.

An object of the present invention is to provide a power saving type compressor in which inputs to opposite sides of a PTC unit are cut off physically after rise of a starting torque in operation of the compressor for preventing unnecessary consumption of the current to provide high energy efficiency.

Another object of the present invention is to provide a refrigerator having a power saving type compressor applied thereto, that prevents unnecessary consumption of a current in operation of the refrigerator for providing high energy efficiency.

Another object of the present invention is to provide a method for controlling a refrigerator having a power saving type compressor applied thereto, that prevents unnecessary consumption of a current in operation of the refrigerator for providing high energy efficiency.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a power saving type compressor includes a main winding and a sub-winding respectively having a main terminal and a sub-terminal, main winding and a sub-winding being connected with a common terminal to each other, and a PTC switching unit between a PTC unit connected to the sub-terminal for increasing a starting torque in operation of the compressor and the main terminal, for making selective switching on/off of a power input to the PTC unit.

A turning off time point of the PTC switching unit is determined with reference to a time period passed from an operation starting time point of the compressor. A turning off time point of the PTC switching unit is determined with reference to a detected current value of the PTC unit.

A turning off time point of the PTC switching unit is determined with reference to a torque value calculated according to RPM of a motor.

In another aspect of the present invention, a power saving type compressor includes a main winding and a sub-winding connected with a common terminal at one sides thereof, a main terminal and a sub-terminal at the other sides of the main winding and the sub-winding, a PTC unit having one side terminal connected to the sub-terminal for making a starting torque greater in operation of the compressor, and a PTC switching unit between the other side terminal of the PTC unit and the main terminal, for making selective switching on/off of a power input to the PTC unit.

A turning off time point of the PTC switching unit is determined with reference to one selected from a time period passed from an operation starting time point of the compressor, a detected current value on the PTC unit, and a torque value calculated according to RPM of a compressor motor.

The PTC switching unit is turned on before the compressor is started.

The power saving type compressor further includes an overload protector to be actuated depending on detection of an over current and a power supply switching unit for turning on/off power to the power supply unit of the compressor, the overload protector and the power supply switching unit being connected in series between one side terminal of the power supply unit and the common terminal.

The power saving type compressor further includes a running capacitor (CR) having one terminal connected to the other side terminal of the power supply unit, and the other terminal connected to the sub-terminal, the running capacitor is arranged in parallel to the PTC unit.

The power saving type compressor further includes a running capacitor (CR) having one terminal connected to the other side terminal of the power supply unit, and the other terminal connected to the sub-terminal, the running capacitor is arranged in parallel to the PTC unit, and a starting capacitor between the sub-terminal and the PTC unit for making a starting torque when currents on the main winding and the sub-winding are balanced.

The power saving type compressor further includes a mode selection switching unit having a terminal connected to the other side of the power supply unit, first, and second relay terminals connected to the main terminal and the sub-terminal respectively, for making selective switching of power supply.

In another aspect of the present invention, a refrigerator for repeating a refrigerating cycle inclusive of compression of refrigerant includes a compressor including a main terminal and a sub-terminal at one sides of a main winding and a sub-winding respectively, a PTC unit having one side terminal connected to the sub-terminal, for making a starting torque greater at the time of operation of the compressor, and a PTC switching unit between the other side terminal of the PTC unit and the main terminal for making selective switching on/off of a power input to the PTC unit, and a control unit for turning off the PTC switching unit after starting of running of the compressor, and turning on the PTC switching unit when running of the compressor is finished.

The control unit turns off the PTC switching unit with reference to one selected from a time period passed from an operation starting time point of the compressor, a detected current value on the PTC unit, and a torque value calculated according to RPM of a compressor motor.

The control unit turns off the PTC switching unit of the compressor when 10˜30 seconds are passed from starting of operation of the compressor.

In another aspect of the present invention, a method for controlling a refrigerator including a power saving type compressor having a PTC unit for making a starting torque greater at the time of operation of the compressor, and a PTC switching unit for making selective turning on/off of a power input to the PTC unit, includes the steps of turning on a power supply switching unit in response to a signal for driving the compressor according to an operation mode of the refrigerator, to start the compressor, counting a time period passed from the start of the operation of the compressor, to determined whether a preset time period is passed, turning off the PTC switching unit to cut off power consumed at the PTC unit if it is determined that the preset time period is passed, keeping the operation in a state the power input to the PTC unit is cut off, and turning off the power supply switching unit of the compressor upon reception of a signal for turning off the compressor, to finish operation of the compressor.

The method further includes the step of turning on the PTC switching unit again upon finish of the operation of the compressor, for initializing the PTC unit for the next cycle.

It is to be understood that both the foregoing general description and the following detailed description of the present invention are exemplary and explanatory and are intended to provide further explanation of the invention as claimed.

### ADVANTAGEOUS EFFECTS

The power saving type compressor, and a refrigerator with the same and a method for controlling the same of the present invention have the following advantages. The physical cut off of the power input to opposite ends of the PTC unit at the time a service of the PTC unit, which is making a starting torque greater after starting of operation, is finished permits consumption of unnecessary energy, which enhances energy efficiency of the compressor, and competitiveness and consumer satisfaction of a product having the compressor applied thereto.

### BRIEF DESCRIPTION OF THE DRAWINGS

The accompanying drawings, which are included to provide a further understanding of the invention, illustrate embodiment(s) of the invention and together with the description serve to explain the principle of the invention. In the drawings;

FIGS. 1 and 2 illustrate systems of related art compressors, respectively;

FIG. 3 illustrates a system of a power saving type compressor in accordance with a first preferred embodiment of the present invention;

FIG. 4 illustrates a system of a power saving type compressor in accordance with a second preferred embodiment of the present invention;

FIG. 5 illustrates a system of a refrigerator having the power saving type compressor in accordance with a third preferred embodiment of the present invention applied thereto;

FIG. 6 illustrates a block diagram of a refrigerator having the power saving type compressor in accordance with a fourth preferred embodiment of the present invention applied thereto;

FIG. 7 illustrates a flow chart showing the steps of a method for controlling a refrigerator having a power saving type compressor of the present invention applied thereto;

FIG. 8 illustrates comparative graphs of operation characteristics of power saving type compressors of the present invention; and

FIG. 9 illustrates a comparative table of operation characteristics of power saving type compressors of the present invention.

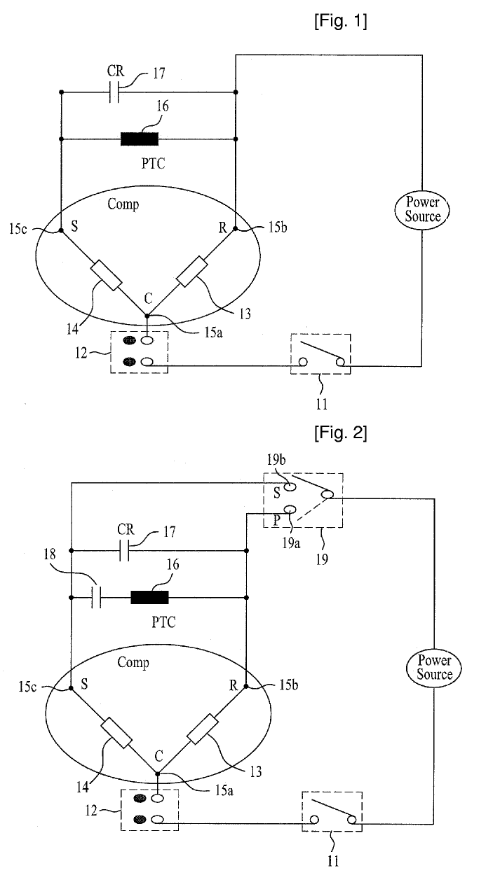

### BEST MODE FOR CARRYING OUT THE INVENTION

Reference will now be made in detail to the preferred embodiments of the present invention, examples of which are illustrated in the accompanying drawings.

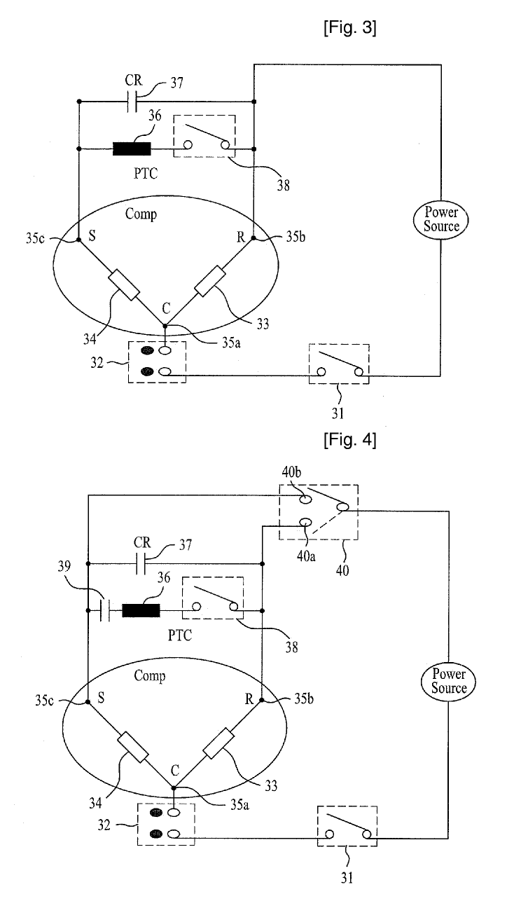

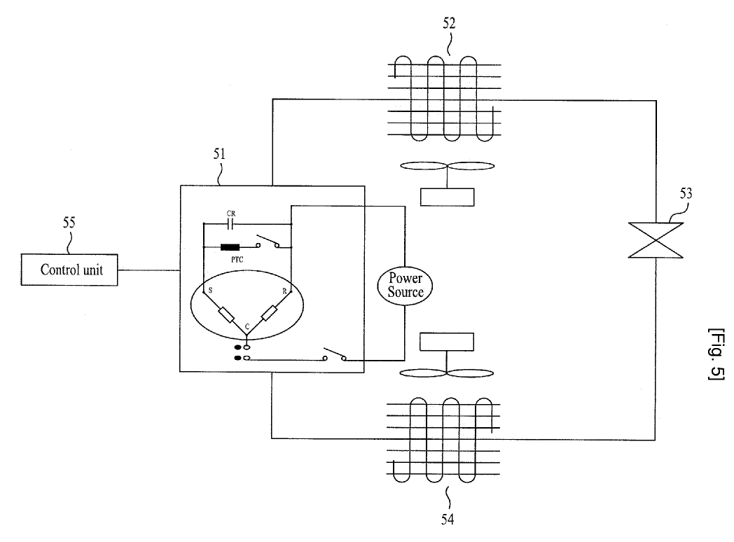

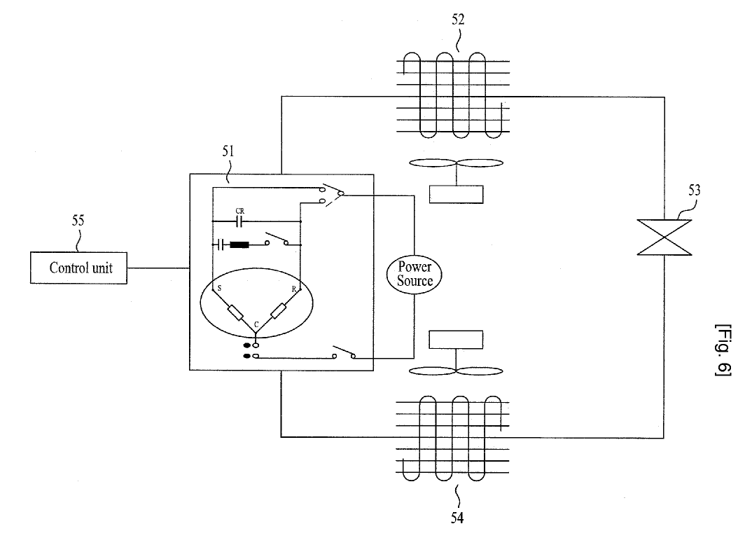

FIG. 3 illustrates a system of a power saving type compressor in accordance with a first preferred embodiment of the present invention, and FIG. 4 illustrates a system of a power saving type compressor in accordance with a second preferred embodiment of the present invention.

The compressor of the present invention includes switching means for physical cutting off of inputs to opposite ends of a PTC unit after rise of a starting torque at the time of operation of the compressor.

At first, a RSCR type compressor having a driving capacitor (CR) of which capacity is fixed will be described.

Referring to FIG. 3, the RSCR type compressor includes a main winding 33, and a sub-winding 34 connected together with a common terminal 35a having line diameters and numbers of winding designed different from each other taking starting characteristics and efficiency of a motor into account, a main terminal 35b at one end of the main winding 23, a sub-terminal 35c at one end of the sub-winding 34, a power supply switching unit 31 for selective turning on/off of power to the compressor, a running capacitor (CR) 37 having a capacity enough to make balance of currents at a rated motor load, and a positive temperature coefficient (PTC) 36 which makes a starting torque greater for serving as a starting switch of the compressor motor, the running capacitor (CR) 37 and the positive temperature coefficient (PTC) 36 being connected in parallel between the sub-terminal 35c and the main terminal 35b, and a PTC switching unit 38 at one side of the PTC unit 36 for selective switching of power to the PTC unit.

The main terminal 35b, and electrodes of the running capacitor 37 and the PTC unit 36 connected to the main terminal 35b are connected to one of terminals of a power supply unit in common.

Between the other terminal of the power supply unit and the common terminal 35a, there are an overload protector (OLP) 32 which is actuated when an over-current is detected for suppressing damage to the compressor motor caused by a load thereon being over a predetermined value, and a power supply switch unit 31 for turning on/off the power.

The power supply switching unit 31 and the PTC switching unit 38 are relay switches, respectively.

By turning on the power supply switching unit 31 after putting the PTC switching unit 38 into a turned on state to put the PTC unit into an operative state, the operation of the compressor is started.

When the starting torque rises adequately after starting the compressor, the PTC switching unit 38 is turned off for cutting off a fine current to the PTC unit.

It is preferable that the turning off of the PTC switching unit 38 is made at a time point when a time period is passed after the starting of the compressor, taking the adequate rise of the starting torque into account.

For an example, it is preferable that the turning off of the PTC switching unit 38 is made at a time point when 10˜30 seconds are passed after the starting of the compressor.

Of course, the power cutting to the PTC unit may be determined, not with reference to a preset time period, but with reference to a current value on the PTC, or with reference to a time point when the rise of the starting torque is adequate determined through a process of a RPM detection of the motor and a calculation of the torque.

Thus, the compressor is operated in a state the unnecessary consumption of power is cut off by means of the PTC unit, and the compressor stops when the power supply switching unit 31 is turned off.

Once the compressor stops, the PTC switching unit 38 is turned on again to set the PTC unit to an initial stage for future driving of the compressor.

A variable capacity type compressor will be described, which has switching means of relays between a power supply terminal and a main terminal and a sub-terminal to enable selection of an operation mode (saving mode, or power mode) by controlling currents flowing on the main winding and the sub-winding.

Referring to FIG. 4, the variable capacity type compressor includes a main winding 33, and a sub-winding 34 connected together with a common terminal 35a having line diameters and numbers of winding designed different from each other taking starting characteristics and efficiency of a motor into account, a main terminal 35b at one end of the main winding 23, a sub-terminal 35c at one end of the sub-winding 34, a power supply switching unit 31 for selective turning on/off of power to the compressor, and a running capacitor (CR) 37 having a capacity enough to make balance of currents at a rated motor load, and a starting capacitor (CS) 38 for making a great starting torque when currents on the main winding 33 and the sub-winding 34 are balanced, wherein the running capacitor (CR) 37 and the starting capacitor (CS) 38 are connected in parallel between the sub-terminal 35c and the main terminal 35b.

There are a positive temperature coefficient (PTC) 36 which makes a starting torque greater between the main terminal 35b and the starting capacitor 39 for serving as a starting switch of the compressor motor, and a PTC switching unit 38 at one side of the PTC unit 36 for selective switching of power supplied to the PTC unit.

The main terminal 35b, and electrodes of the running capacitor 37 and the PTC unit 36 connected to the main terminal 35b are connected to one 40a of terminals of a mode selection switching unit 40 which selects an operation mode of the compressor.

The mode selection switching unit 40 is composed of a terminal connected to the power supply unit, and first, and second relays 40a, and 40b respectively connected to the main terminal 35b and the sub-terminal 35c, for being switched in response to a mode selection signal to let a current flow to the main winding 33 or to the sub-winding 34, for driving the compressor either in the power mode or in the saving mode.

Between the other terminal of the power supply unit and the common terminal 35a, there are an overload protector (OLP) 32 which is actuated when an over-current is detected for suppressing damage to the compressor motor caused by a load thereon being a predetermined value and a power supply switch unit 31 for turning on/off the power.

The power supply switching unit 31, the PTC switching unit 38, and the mode selection switching unit 40 are relay switches, respectively.

The operation mode of the variable capacity type compressor is set up depending on the terminal on the power supply unit side of the mode selection switching unit 40 being connected to which one of the first, and second relay terminals 40a, and 40b, and if the power supply switching unit 31 is turned on in this state, the compressor is operated in the set up operation mode.

When the starting torque rises adequately after starting the compressor, the PTC switching unit 38 is turned off for cutting off a fine current to the PTC unit.

It is preferable that the turning off of the PTC switching unit 38 is made at a time point when a time period is passed after the starting of the compressor, taking the adequate rise of the starting torque into account.

For an example, it is preferable that the turning off of the PTC switching unit 38 is made at a time point when 10˜30 seconds are passed after the starting of the compressor.

Of course, the power cutting to the PTC unit may be determined, not with reference to a preset time period, but with reference to a current value on the PTC, or with reference to a time point when the rise of the starting torque is adequate determined through a process of a RPM detection of the motor and a calculation of the torque.

Thus, the compressor is operated in a state the unnecessary consumption of power is cut off by means of the PTC unit, and the compressor stops when the power supply switching unit 31 is turned off.

Once the compressor stops, the PTC switching unit 38 is turned on again to set the PTC unit to an initial stage for future running of the compressor.

Because the PTC switching unit cuts off inputs to the PTC unit after rise of the starting torque, the PTC switching unit being at one side of the PTC unit connected between the sub-terminal and the main terminal to make a starting torque for serving as a starting switch of the compressor motor, unnecessary waste of power can be prevented.

A refrigerator having the power saving type compressor applied thereto, and a method for controlling the same will be described.

FIG. 5 illustrates a system of a refrigerator having the power saving type compressor in accordance with a third preferred embodiment of the present invention applied thereto, and FIG. 6 illustrates a block diagram of a refrigerator having the power saving type compressor in accordance with a fourth preferred embodiment of the present invention applied thereto.

“a refrigerator” described hereinafter is a concept inclusive of refrigerating systems having the refrigerating cycle applied thereto, such as freezers, kimchi refrigerators, in addition to general domestic refrigerators each having a refrigerating chamber and a freezing chamber.

The refrigerator repeats a refrigerating cycle in which refrigerant (working fluid) is compressed, condensed, expanded, and evaporated, for cooling down chambers of the refrigerator, to maintain food therein fresh for a certain time period.

The refrigerator has the refrigerating cycle including, as basic units, a compressor 51 for elevating temperature and pressure of low temperature/low pressure gaseous refrigerant to high temperature/high pressure gaseous refrigerant, a condenser 52 for condensing the refrigerant from the compressor 51 by using outdoor air, an expansion valve 53 having a diameter smaller than other portions for de-pressurizing the refrigerant from the condenser, and an evaporator 54 for evaporating the refrigerant passed through the expansion valve 53 to absorb heat from the refrigerator.

A cooling capacity of the refrigerating cycle of the refrigerator is fixed according to a compressing capacity of the compressor.

Referring to FIG. 5, the refrigerator of the present invention with the refrigerating cycle having the power saving type compressor applied thereto comprises a compressor including a main winding, and a sub-winding connected together with a common terminal, a running capacitor (CR) having a capacity enough to make balance of currents at a rated motor load, and a positive temperature coefficient (PTC) unit which makes a starting torque greater for serving as a starting switch of the compressor motor, the running capacitor (CR) 37 and the positive temperature coefficient (PTC) 36 being connected in parallel between the sub-terminal 35c and the main terminal 35b, and a PTC switching unit at one side of the PTC unit for selective switching of power to the PTC unit, for cutting off inputs to opposite ends of the PTC unit by turning off the PTC switching unit at a time point determined that the starting torque rises adequately after starting of operation of the compressor under the control of a control unit 55.

Once the compressor stops, the control unit 55 controls such that the PTC switching unit 38 is turned on again to set the PTC unit to an initial stage.

Referring to FIG. 6, a refrigerator having the power saving type compressor of a variable capacity type applied thereto in accordance with another preferred embodiment of the present invention comprises a compressor including a main winding and a sub-winding connected together with a common terminal, a running capacitor (CR) having a capacity enough to make balance of currents at a rated motor load, and a starting capacitor (CS) for making a great starting torque when currents on the main winding and the sub-winding are balanced, wherein the running capacitor (CR) and the starting capacitor (CS) are connected in parallel between the sub-terminal and the main terminal, a positive temperature coefficient (PTC) unit which makes a starting torque greater connected to the starting capacitor in series for serving as a starting switch of the compressor motor, a PTC switching unit at one side of the PTC unit for selective switching of power to the PTC unit, and a mode selection switching unit having a terminal connected to the power supply unit, and first, and second relay terminals respectively connected to the main terminal and the sub-terminal, for being switched in response to a mode selection signal to let a current flow to the main winding or to the sub-winding 14, for driving the compressor either in the power mode or in the saving mode, for cutting off inputs to opposite ends of the PTC unit by turning off the PTC switching unit at a time point determined that the starting torque rises adequately after starting of operation of the compressor under the control of a control unit 55.

In this instance, the control unit 55 determines the turning off time point of the PTC switching unit as a time point when the starting torque rises adequately, for an example, when 10˜30 seconds are passed after starting of the compressor, or with reference to a current value detected on the PTC unit, or when the rise of the starting torque is adequate through a process of RPM detection of the motor and calculation of the torque.

Once the compressor stops, the control unit controls such that the PTC switching unit is turned on again to set the PTC unit to an initial stage.

A method for controlling a refrigerator having a power saving type compressor of the present invention applied thereto.

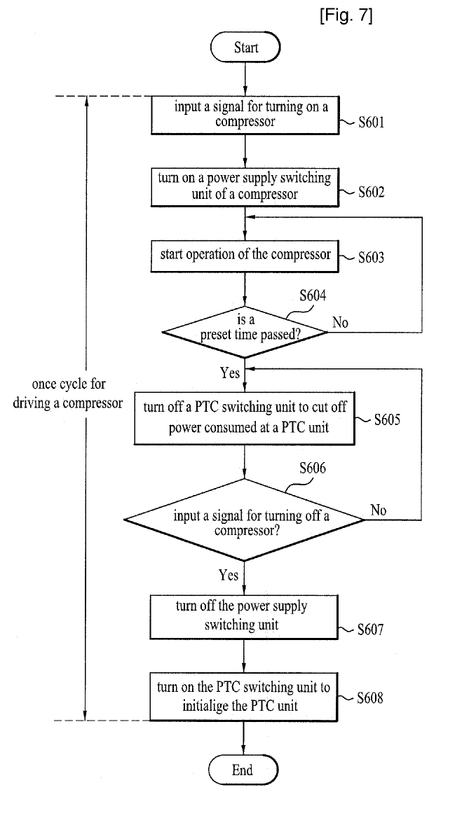

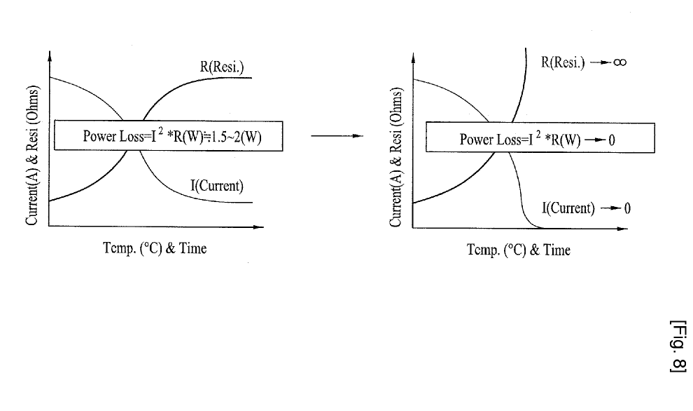

FIG. 7 illustrates a flow chart showing the steps of a method for controlling a refrigerator having a power saving type compressor of the present invention applied thereto.

In operation of the refrigerator having the power saving type compressor of the present invention applied thereto, if a turning on signal of the compressor is received in response to a control signal from a control unit proper to an operation mode (S601), a power supply switching unit of the compressor is turned on (S602), to start operation of the compressor (S603).

Following operation of the compressor, the refrigerant (working fluid) is involved in repetitive compression-condensation-expansion-evaporation for cooling the chambers of the refrigerator.

A time period passed from the starting of the operation of the compressor is counted, to determined if a preset time period is passed or not (S604).

If it is determined that the present time period is passed, the PTC switching unit is turned off, to cut of power consumed by the PTC unit (S605).

It is determined whether a signal for turning off the compressor is inputted, while the operation of the compressor is kept on in a state the power input to the PTC unit is cut off (S606), and if the signal for turning off the compressor is inputted, the power supply switching unit is turned off, to finish the operation of the compressor (S607).

If the operation of the compressor is finished thus, the PTC switching unit is turned on again, to initialize the PTC unit so as to be ready for the next cycle (S608).

Energy efficiency of the power saving type compressor and the refrigerator having same applied thereto will be discussed.

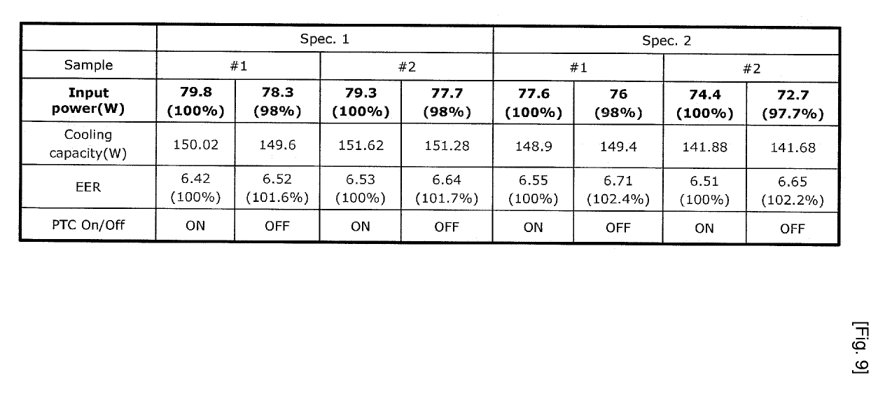

FIG. 8 illustrates comparative graphs of operation characteristics of power saving type compressors of the present invention, and FIG. 9 illustrates a comparative table of operation characteristics of power saving type compressors of the present invention.

A left side graph in FIG. 8 illustrates characteristics in a case when the compressor and the refrigerator are operated without physical turning off of the PTC unit after starting of the compressor and the refrigerator, showing that a current is consumed continuously due to failure of continuous increase of a resistance of the PTC unit as time passes by.

That is, once operation of the compressor is started, though it is required that the rise of the starting torque is made adequate by the PTC unit, and there is no current consumed by the PTC unit thereafter, it can be known that there is a power loss [=I²*R(W)≈1.5˜2(W)].

Compared to this, as shown in a right side graph in FIG. 8, it can be known that the power saving type compressor and the refrigerator of the present invention turns off the PTC unit physically, such that the PTC unit has a resistance increased continuously as time passes by, and the resistance becomes infinity (∞) after the physical turn off of the PTC unit such that the PTC unit consumes no current.

That is, upon starting of operation of the compressor, the starting torque rises adequately by the PTC unit, and thereafter, the PTC unit is turned off physically, to cause no power loss [=I²*R(W)→0].

FIG. 9 illustrates energy efficiency ratios (EER) varied with the physical turn on/off of the PTC unit after starting of the compressor under the condition that the cooling capacity is the same.

It can be known that the EERs are improved in all of the samples (spec. 1#1, and #2) (spec. 2#1, #2) if there are the physical turn off of the PTC unit.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

### INDUSTRIAL APPLICABILITY

The present invention relates to a compressor and a refrigerator with the same, and more particularly, to a power saving type compressor which can prevent unnecessary consumption of a current for the compressor to have high energy efficiency, and a refrigerator with the same and a method for controlling the same.

1. A power saving type compressor comprising:
a main winding and a sub-winding respectively having a main terminal and a sub-terminal, main winding and a sub-winding being connected with a common terminal to each other; and
a PTC switching unit between a PTC unit connected to the sub-terminal for increasing a starting torque in operation of the compressor and the main terminal, for making selective switching on/off of a power input to the PTC unit.

2. The power saving type compressor as claimed in claim 1, wherein a turning off time point of the PTC switching unit is determined with reference to a time period passed from an operation starting time point of the compressor.

3. The power saving type compressor as claimed in claim 1, wherein a turning off time point of the PTC switching unit is determined with reference to a detected current value of the PTC unit.

4. The power saving type compressor as claimed in claim 1, wherein a turning off time point of the PTC switching unit is determined with reference to a torque value calculated according to RPM of a motor.

5. A power saving type compressor comprising:
a main winding and a sub-winding connected with a common terminal at one sides thereof;
a main terminal and a sub-terminal at the other sides of the main winding and the sub-winding;
a PTC unit having one side terminal connected to the sub-terminal for making a starting torque greater in operation of the compressor; and
a PTC switching unit between the other side terminal of the PTC unit and the main terminal, for making selective switching on/off of a power input to the PTC unit.

6. The power saving type compressor as claimed in claim 5, wherein a turning off time point of the PTC switching unit is determined with reference to one selected from a time period passed from an operation starting time point of the compressor, a detected current value on the PTC unit, and a torque value calculated according to RPM of a compressor motor.

7. The power saving type compressor as claimed in claim 5, wherein the PTC switching unit is turned on before the compressor is started.

8. The power saving type compressor as claimed in claim 5, further comprising an overload protector to be actuated depending on detection of an over current and a power supply switching unit for turning on/off power to the power supply unit of the compressor, the overload protector and the power supply switching unit being connected in series between one side terminal of the power supply unit and the common terminal.

9. The power saving type compressor as claimed in claim 8, further comprising a running capacitor (CR) having one terminal connected to the other side terminal of the power supply unit, and the other terminal connected to the sub-terminal, the running capacitor is arranged in parallel to the PTC unit.

10. The power saving type compressor as claimed in claim 8, further comprising:
a running capacitor (CR) having one terminal connected to the other side terminal of the power supply unit, and the other terminal connected to the sub-terminal, the running capacitor is arranged in parallel to the PTC unit; and
a starting capacitor between the sub-terminal and the PTC unit for making a starting torque when currents on the main winding and the sub-winding are balanced.

11. The power saving type compressor as claimed in claim 8, further comprising a mode selection switching unit having a terminal connected to the other side of the power supply unit, first, and second relay terminals connected to the main terminal and the sub-terminal respectively, for making selective switching of power supply.

12. A refrigerator for repeating a refrigerating cycle inclusive of compression of refrigerant comprising:
a compressor including a main terminal and a sub-terminal at one sides of a main winding and a sub-winding respectively, a PTC unit having one side terminal connected to the sub-terminal, for making a starting torque greater at the time of operation of the compressor, and a PTC switching unit between the other side terminal of the PTC unit and the main terminal for making selective switching on/off of a power input to the PTC unit; and
a control unit for turning off the PTC switching unit after starting of running of the compressor, and turning on the PTC switching unit when running of the compressor is finished.

13. The refrigerator as claimed in claim 12, wherein the control unit turns off the PTC switching unit with reference to one selected from a time period passed from an operation starting time point of the compressor, a detected current value on the PTC unit, and a torque value calculated according to RPM of a compressor motor.

14. The refrigerator as claimed in claim 13, wherein the control unit turns off the PTC switching unit of the compressor when 10˜30 seconds are passed from starting of operation of the compressor.

15. A method for controlling a refrigerator including a power saving type compressor having a PTC unit for making a starting torque greater at the time of operation of the compressor, and a PTC switching unit for making selective turning on/off of a power input to the PTC unit, comprising the steps of:
turning on a power supply switching unit in response to a signal for driving the compressor according to an operation mode of the refrigerator, to start the compressor;
counting a time period passed from the start of the operation of the compressor, to determined whether a preset time period is passed;
turning off the PTC switching unit to cut off power consumed at the PTC unit if it is determined that the preset time period is passed;
keeping the operation in a state the power input to the PTC unit is cut off; and
turning off the power supply switching unit of the compressor upon reception of a signal for turning off the compressor, to finish operation of the compressor.

16. The method as claimed in claim 15, further comprising the step of turning on the PTC switching unit again upon finish of the operation of the compressor, for initializing the PTC unit for the next cycle.
